(19) United States
(12) Patent Application Publication
(10) Pub. No.: US 2014/0375410 A1
(43) Pub. Date: Dec. 25, 2014

(54) TRANSFORMER, MAGNETIC CORE AND BOBBIN THEREOF

(71) Applicant: DELTA ELECTRONICS, INC., Toayuan Hsien (TW)

(72) Inventors: Chun-Ching Yen, Taoyuan Hsien (TW); Hsien-Chun Peng, Taoyuan Hsien (TW); Yue Tsao, Taoyuan Hsien (TW); Po-Yu Wei, Taoyuan Hsien (TW)

(73) Assignee: DELTA ELECTRONICS, INC., Toayuan Hsien (TW)

(21) Appl. No.: 14/161,422

(22) Filed: Jan. 22, 2014

(30) Foreign Application Priority Data
Jun. 19, 2013 (CN) 201310244510.9

(51) Int. Cl. H01F 27/30; H01F 27/24

(52) U.S. Cl. CPC H01F 27/306; H01F 27/24
USPC 336/198; 336/233

(57) ABSTRACT

A transformer includes a magnetic core assembly, a bobbin, and a winding coil assembly. The magnetic core assembly includes a first magnetic core and a second magnetic core. Each of the first magnetic core and the second magnetic core includes a magnetic plate, a center leg, a first lateral leg, and a second lateral leg. The first lateral leg and the second lateral leg are disposed on two opposite edges of the magnetic plate. The magnetic plate has a thinned region. The thinned region is defined by the first lateral leg, the second lateral leg and the center leg collaboratively. The bobbin has an engaging structure corresponding to the thinned region. When the bobbin is arranged between the first magnetic core and the second magnetic core, the engaging structure of the bobbin is engaged with the thinned region. The winding coil assembly is wound on the bobbin.

### TECHNICAL FIELD

The present disclosure relates to a structure of transformer, and more particularly to a slim-type transformer including a magnetic core assembly having thinned regions. The electrical characteristics of the transformer aren't obviously impaired by employing the magnetic core assembly having the thinned regions. The present disclosure also relates to a magnetic core and a bobbin for the transformer.

### BACKGROUND OF THE DISCLOSURE

A transformer is a magnetic device that transfers electric energy from one circuit to another circuit through coils in order to regulate the voltage to a desired range for powering an electronic device. Conventionally, the transformer comprises a bobbin, a magnetic core assembly, a primary winding coil, and a secondary winding coil. The primary winding coil and the secondary winding coil are wound around a winding section of the bobbin. During operations of the transformer, an input voltage is inputted into the primary winding coil, the magnetic core assembly is subjected to electromagnetic induction, and the regulated voltage is outputted from the secondary winding coil.

In the conventional transformer, the magnetic core assembly and the bobbin have fixed thicknesses. After the magnetic core assembly and the bobbin are combined together, the overall thickness of the transformer is substantially determined according to the thickness of the magnetic core assembly and the thickness of the bobbin. Recently, the general trends in electronic device are toward small size, miniaturization and slimness. Correspondingly, the volume of the transformer for use in the electronic device should be reduced. In other words, the manufactures of transformers make efforts in reducing the thicknesses of the transformers.

For reducing the thickness of the transformer, many researches pay much attention on the thickness reduction of the bobbin. However, there are not many researches about the thickness reduction of the magnetic core assembly. As known, if the magnetic core assembly is thinned, the overall structural strength of the transformer is impaired. Moreover, after the magnetic core assembly is thinned, the magnetic path of the magnetic core assembly is possibly deteriorated. Under this circumstance, the magnetic core assembly is easy to become magnetic saturation, and thus the electrical characteristics of the transformer are adversely affected.

Therefore, there is a need of providing a transformer including a magnetic core assembly having thinned regions while avoiding the above drawbacks.

### SUMMARY OF THE DISCLOSURE

The present disclosure provides a transformer including a magnetic core assembly having thinned regions. The present disclosure also provides a magnetic core and a bobbin for the transformer. In this transformer, the thinned region of the magnetic core assembly has relatively low magnetic flux density, the influence of the thinned region on the overall magnetic flux of the transformer can be ignored, and the electrical characteristics are not obviously impaired. Moreover, the material cost of the magnetic core assembly is reduced, the structural strength of the bobbin is enhanced, and the overall thickness of the transformer is reduced for solving the bulk volume issues of the transformer encountered by the prior arts.

In accordance with an aspect of the present disclosure, there is provided a transformer. The transformer includes a magnetic core assembly, a bobbin, and a winding coil assembly. The magnetic core assembly includes a first magnetic core and a second magnetic core. Each of the first magnetic core and the second magnetic core includes a magnetic plate, a center leg, a first lateral leg, and a second lateral leg. The first lateral leg and the second lateral leg are disposed on two opposite edges of the magnetic plate. The magnetic plate has at least one thinned region. The at least one thinned region is defined by the first lateral leg, the second lateral leg and the center leg collaboratively. The bobbin includes a winding section. In addition, the bobbin has at least one engaging structure corresponding to the at least one thinned region. When the bobbin is arranged between the first magnetic core and the second magnetic core, the at least one engaging structure of the bobbin is engaged with the at least one thinned region. The winding coil assembly is wound on the winding section of the bobbin.

In accordance with another aspect of the present disclosure, there is provided a magnetic core. The magnetic core includes a magnetic plate, a center leg, a first lateral leg and a second lateral leg. The magnetic plate has at least one thinned region. The center leg is vertically protruded from a surface of the magnetic plate. The first lateral leg is vertically protruded from the surface of the magnetic plate. The second lateral leg is vertically protruded from the surface of the magnetic plate. The first lateral leg and the second lateral leg are disposed on two opposite edges of the magnetic plate. The thinned region is defined by the first lateral leg, the second lateral leg and the center leg collaboratively.

In accordance with another aspect of the present disclosure, there is provided a bobbin for a transformer. The transformer includes a magnetic core having at least one thinned region. The bobbin includes a main body, a top plate, a bottom plate and at least one engaging structure. The main body has a channel. The top plate and the bottom plate are disposed on two opposite ends of the main body respectively. The main body, the top plate and the bottom plate define a winding section for winding at least one winding coil thereon. The channel passes through the main body, the top plate and the bottom plate. The at least one engaging structure is formed on an outer surface of the top plate or the bottom plate for engaging with the at least one thinned region of the magnetic core.

The above contents of the present disclosure will become more readily apparent to those ordinarily skilled in the art after reviewing the following detailed description and accompanying drawings, in which:

### BRIEF DESCRIPTION OF THE DRAWINGS

FIG. 1 is a schematic exploded view illustrating a transformer according to an embodiment of the present disclosure;

FIG. 2 is a schematic perspective view illustrating an exemplary magnetic core of the magnetic core assembly of the transformer according to the present disclosure;

FIG. 3A is a schematic exploded view illustrating a transformer according to another embodiment of the present disclosure;

FIG. 3B is a schematic perspective view illustrating an exemplary magnetic core of the magnetic core assembly of the transformer of FIG. 3A; and

FIG. 4 is a schematic perspective view illustrating another exemplary magnetic core of the magnetic core assembly of the transformer according to the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed.

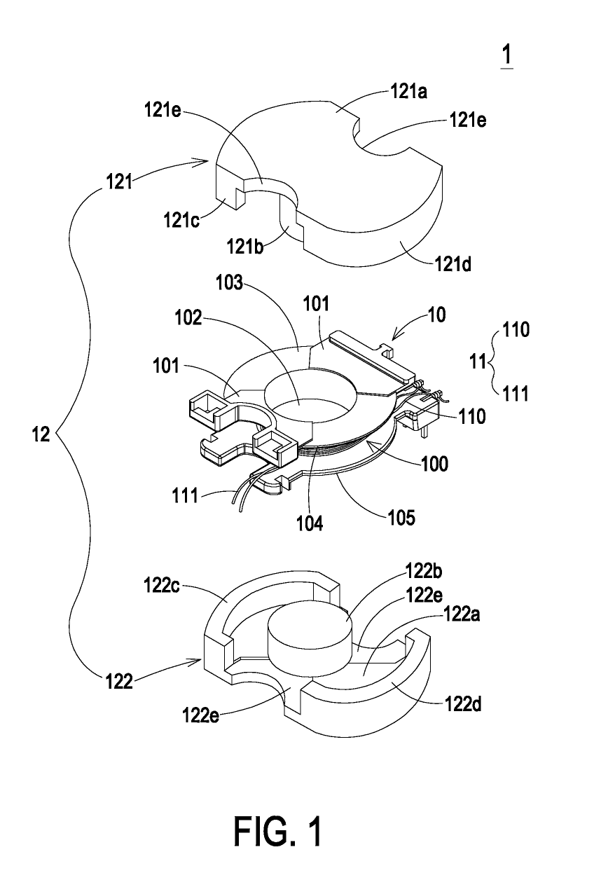

FIG. 1 is a schematic exploded view illustrating a transformer according to an embodiment of the present disclosure. As shown in FIG. 1, the transformer 1 comprises a bobbin 10, a winding coil assembly 11, and a magnetic core assembly 12. The bobbin 10 comprises a winding section 100. The winding coil assembly 11 is wound on the winding section 100 of the bobbin 10. In this embodiment, the winding coil assembly 11 comprises a primary winding coil 110 and a secondary winding coil 111. The magnetic core assembly 12 comprises a first magnetic core 121 and a second magnetic core 122. The first magnetic core 121 comprises a magnetic plate 121a, a center leg 121b, a first lateral leg 121c, and a second lateral leg 121d. The first lateral leg 121c and the second lateral leg 121d are disposed on two opposite edges of the magnetic plate 121a. Similarly, the second magnetic core 122 comprises a magnetic plate 122a, a center leg 122b, a first lateral leg 122c, and a second lateral leg 122d. The first lateral leg 122c and the second lateral leg 122d are disposed on two opposite edges of the magnetic plate 122a. In accordance with a feature of the present disclosure, the magnetic plate 121a of the first magnetic core 121 has at least one thinned region 121e and the magnetic plate 121a of the first magnetic core 121 has a step structure 121h formed by the thinned region 121e, and the magnetic plate 122a of the second magnetic core 122 has at least one thinned region 122e and the second magnetic plate 122a of the second magnetic core 122 has a step structure formed by the thinned region 122e. The thinned region 121e of the first magnetic core 121 is defined by the first lateral leg 121c, the second lateral leg 121d and the center leg 121b collaboratively; and the thinned region 122e of the second magnetic core 122 is defined by the first lateral leg 122c, the second lateral leg 122d and the center leg 122b collaboratively. The bobbin 10 has engaging structures 101 corresponding to the thinned regions 121e of the first magnetic core 121 and the thinned regions 122e of the second magnetic core 122, respectively. Preferably, the engaging structures 101 of the bobbin 10 are increased thickness portions of the bobbin 101. When the bobbin 10 is assembled with the first magnetic core 121 and the second magnetic core 122, the engaging structures 10 are engaged with the corresponding thinned regions 121e and 122e.

Please refer to FIG. 1 again. The bobbin 10 is a slim-type bobbin with the winding section 100. The bobbin 10 includes a main body 103, a top plate 104, a bottom plate 105 and one or more engaging structures 101. The top plate 104 and the bottom plate 105 are disposed on two opposite ends of the main body 103. The main body 103, the top plate 104 and the bottom plate 105 define the winding section 100. The main body has a channel 102, and the channel 102 passes through the main body 103, the top plate 104 and the bottom plate 105. After the primary winding coil 110 and the secondary winding coil 111 of the winding coil assembly 11 are wound around the winding section 100, the ends of the primary winding coil 110 and the secondary winding coil 111 are outputted from bilateral sides of the bobbin 10. The bobbin 10 has engaging structures 101 corresponding to the thinned regions 121e and 122e of the magnetic core assembly 12. The engaging structures 101 of the bobbin 10 are respectively formed on an outer surface of the top plate 104 and an outer surface of a bottom plate 105, and the outer surface of the top plate 104 is opposite to the outer surface of the bottom plate 105. The numbers and profiles of the engaging structures 101 of the bobbin 10 are determined according to those of the thinned regions of the magnetic core assembly 12.

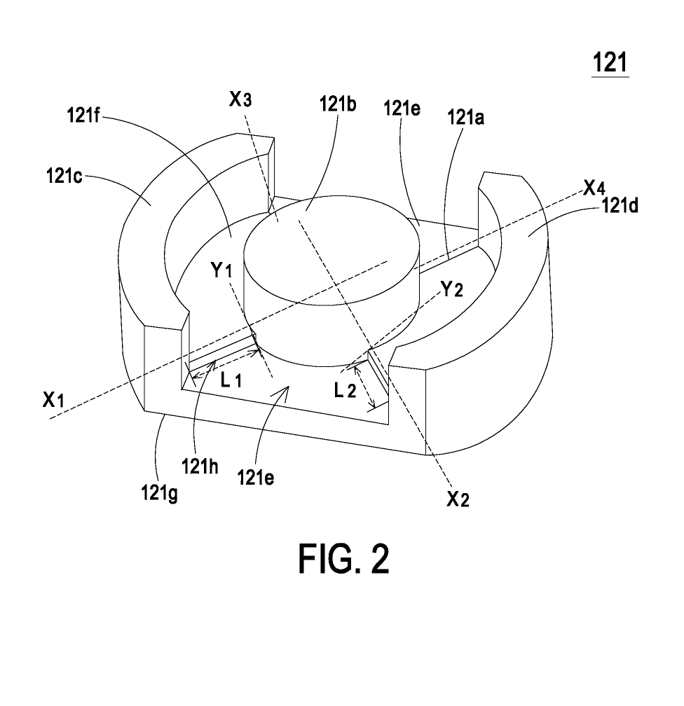

FIG. 2 is a schematic perspective view illustrating an exemplary magnetic core of the magnetic core assembly of the transformer according to the present disclosure. Since the first magnetic core 121 and the second magnetic core 122 have identical structures, for clarification and brevity, only the first magnetic core 121 will be described. In this embodiment, each of the first magnetic core 121 and the second magnetic core 122 is a PJ core, but it is not limited thereto. The first magnetic core 121 comprises the magnetic plate 121a, the center leg 121b, the first lateral leg 121c, and the second lateral leg 121d. In this embodiment, the bottom surface 121g of the magnetic plate 121a is flat, and the magnetic plate 121a has two thinned regions 121e, which are symmetrical with each other. The center leg 121b is a cylindrical post and located at the center of the magnetic plate 121a. The center leg 121b is vertically protruded from the top surface 121f of the magnetic plate 121a. The first lateral leg 121c and the second lateral leg 121d are disposed on two opposite edges of the magnetic plate 121a, and vertically protruded from the top surface 121f of the magnetic plate 121a. Moreover, the first lateral leg 121c and the second lateral leg 121d are separated from each other.

Please refer to FIG. 2 again. A first extending line X1 tangent to an end edge of the first lateral leg 121c and vertical to a first tangential line Y1 tangent to an edge of the center leg 121b is provided, and a shortest distance between the end edge of the first lateral leg 121c and the center leg 121b is obtained according to the first extending line X1. Namely, a first length L1 is the shortest distance between the end edge of the first lateral leg 121c and the center leg 121b. Similarly, a third extending line X3 tangent to the other end edge of the first lateral leg 121c and vertical to a tangential line (not shown) tangent to an edge of the center leg 121b is provided. In addition, a second extending line X2 tangent to an end edge of the second lateral leg 121d and vertical to a second tangential line Y2 tangent to an edge of the center leg 121b is provided, and a shortest distance between the end edge of the second lateral leg 121d and the center leg 121b is obtained according to the second extending line X2. Namely, a second length L2 is the shortest distance between the end edge of the second lateral leg 121d and the center leg 121b. Similarly, a fourth extending line X4 tangent to the other end edge of the second lateral leg 121d and vertical to a tangential line (not shown) tangent to an edge of the center leg 121b is provided. A first region defined by the first extending line X1, the third extending line X3, the first lateral leg 121c and the center leg 121b and a second region defined by the second extending line X2, the fourth extending line X4, the second lateral leg 121d and the center leg 121b are the regions having the shortest magnetic paths of the first magnetic core 121, when the transformer 1 is subjected to electromagnetic induction. Namely, when the transformer 1 is subjected to electromagnetic induction, the first length L1 and the second length L2 have the shortest magnetic paths. Since the magnitude of a magnetomotive force F is equal to the product of the magnitude of a magnetic field intensity H and the distance L (i.e. F=H×L), the magnetic field intensity H is inverse proportion to the distance L. In other words, the magnetic field intensity H corresponding to the first length L1 or the second length L2 is the largest. Moreover, since the magnetic flux density B is in direct proportion to the magnetic field intensity H (e.g. B=μ×H), the magnetic flux density B corresponding to the first length L1 or the second length L2 is the largest. Consequently, the first and second regions of first magnetic core 121 have relatively large magnetic flux density when the transformer 1 is subjected to electromagnetic induction.

On the other hand, a region having relatively low magnetic flux density can be found according to simulation. Namely, the thinned region 121e has relatively low magnetic flux according to simulation. A first side of the thinned region 121e is determined according to the first length L1, and a second side of the thinned region 121e is determined according to the second length L2. Consequently, the influence of the thinned region 121e on the overall magnetic flux of the transformer 1 can be ignored. Simulation showed that the magnetic flux of the transformer 1 with the thinned region 121e is substantially identical to the magnetic flux of the transformer without the thinned region of the magnetic core. In other words, although the transformer 1 of the present disclosure has the thinned region 121e, the electrical characteristics are not obviously impaired.

Please refer to FIGS. 1 and 2 again. In this embodiment, the thinned region 121e of the first magnetic core 121 is a concave structure. That is, the thinned region 121e is produced by cutting a part of the magnetic plate 121a. Moreover, the engaging structure 101 of the bobbin 10 is a convex structure corresponding to the concave structure of the thinned region 121e. Consequently, when the bobbin 10 is arranged between and assembled with the first magnetic core 121 and the second magnetic core 122, the engaging structures 101 of the bobbin 10 are engaged with the thinned regions 121e, 122e. Since the engaging structures 101 can increase the structural strength of the bobbin 10, the possibility of causing deformation of the bobbin 10 during the winding process will be minimized.

In this embodiment, the first magnetic core 121 has two thinned regions 121e. One thinned region 121e is defined by the first extending line X1 and the second extending line X2, and the other thinned region 121e is defined by the third extending line X3 and the fourth extending line X4. These two thinned regions 121e are located beside two entrances between the first lateral leg 121c and the second lateral leg 121d of the first magnetic core 121, respectively. However, the number of the thinned regions 121e may be varied according to the practical requirements.

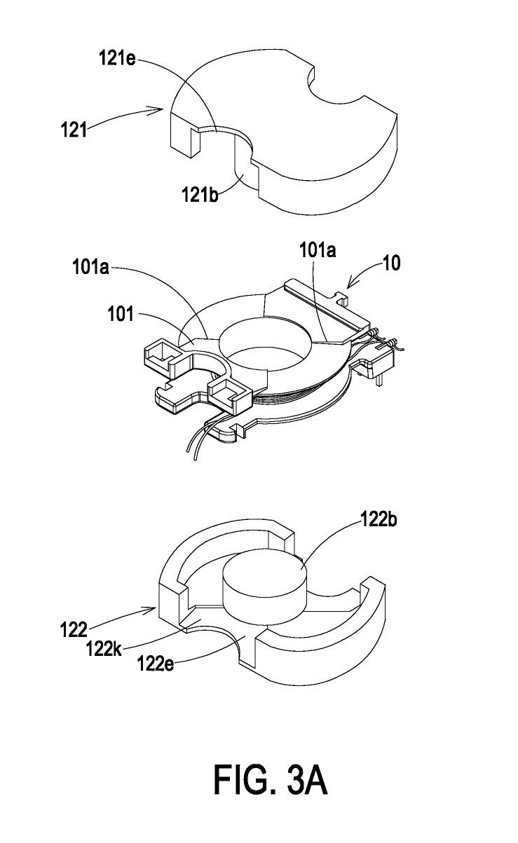

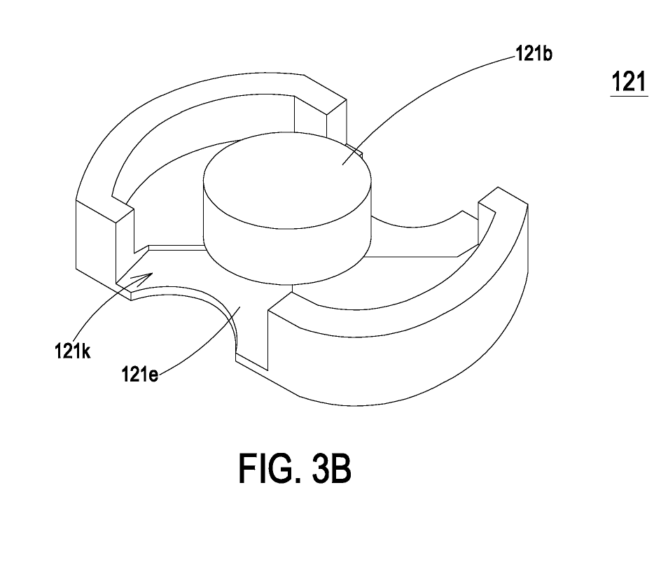

It is noted that the numerous modifications and alterations of the thinned region may be made while retaining the teachings of the disclosure. For example, as shown in FIGS. 3A and 3B, in some other embodiments, the thinned region 121e, 122e has a first slant 121k, 122k, and the engaging structure 101 has a second slant 101a corresponding to the thinned region 121e, 122e. Preferably, the first slant 121k, 122k is slant from the center leg 121b, 122b to the exterior, and the second slant 101a is slant from the exterior to the interior. Under this circumstance, the engaging structures 101 of the bobbin 10 and the thinned regions 121e, 122e are still engaged with each other.

Hereinafter, a process of assembling the transformer 1 will be illustrated by referring to FIG. 1 again. Firstly, a bobbin 10 is provided. Then, the primary winding coil 110 and the secondary winding coil 111 of the winding coil assembly 11 are wound on the winding section 100 of the bobbin 10. In addition, the ends of the primary winding coil 110 and the secondary winding coil 111 are outputted from bilateral sides of the bobbin 10. Then, the center leg 121b of the first magnetic core 121 and the center leg 122b of the second magnetic core 122 are inserted into a channel 102 of the bobbin 10. At the same time, the engaging structures 101 on an outer surface of the top plate of the bobbin 10 are engaged with the thinned regions 121e of the first magnetic core 121, and the engaging structures 101 on an outer surface of the bottom plate of the bobbin 10 are engaged with the thinned regions 122e of the second magnetic core 122. Consequently, the bobbin 10 is securely installed between the first magnetic core 121 and the second magnetic core 122. Then, the ends of the primary winding coil 110 and the secondary winding coil 111 are welded on corresponding pins (not shown) of the bobbin 10. Afterwards, an insulating medium (not shown) is wound around the magnetic core assembly 12. As a consequence, the transformer 1 of the present disclosure is assembled.

From the above discussions, since the first magnetic core 121 and the second magnetic core 122 have the thinned regions 121e and 122e, the material cost of the magnetic core assembly 12 is reduced. Moreover, in case that a slim-type magnetic core assembly is used as the magnetic core assembly 12 of the transformer 1, the overall thickness of the transformer 1 is reduced while maintaining a desired structural strength of the bobbin 10.

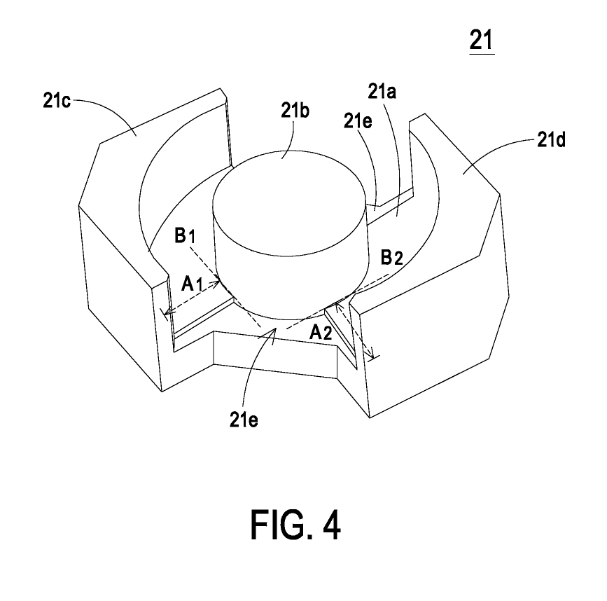

FIG. 4 is a schematic perspective view illustrating another exemplary magnetic core of the magnetic core assembly of the transformer according to the present disclosure. Similarly, the first magnetic core 21 comprises a magnetic plate 21a, a center leg 21b, a first lateral leg 21c, and a second lateral leg 21d. A first length A1 is the shortest distance between an end edge of the first lateral leg 21c and a tangential line B1 tangent to an edge of the center leg 21b. Similarly, a second length A2 is the shortest distance between an end edge of the second lateral leg 21d and a tangential line B2 tangent to an edge of the center leg 21b. A first side of the thinned region 21e is determined according to the first length A1, and a second side of the thinned region 21e is determined according to the second length A2. In this embodiment, the first magnetic core 21 has two thinned regions 21e, which are symmetrical with each other. In this embodiment, the first magnetic core 21 is a RM core. It is noted that the magnetic core used in the transformer of the present disclosure is not restricted to the PJ core or the RM core. After the regions of the magnetic core with the relatively low magnetic flux are realized by simulation, these regions may be defined as the thinned regions. By cutting the parts of the magnetic plate corresponding to the thinned regions, the magnetic core with the thinned regions is obtained. After the magnetic core assembly with the thinned regions and the slim-type bobbin are combined together, the overall thickness of the transformer can be reduced.

From the above descriptions, the present disclosure provides a transformer. The transformer comprises a magnetic core assembly, a winding coil assembly, and a bobbin. The magnetic core assembly comprises a first magnetic core and a second magnetic core. Each of the first magnetic core and the second magnetic core has at least one thinned region. The thinned region has relatively low magnetic flux. Moreover, the thinned region may be produced by cutting a part of the magnetic core. The bobbin has at least one engaging structure corresponding to the thinned region. Due to the at least one thinned region, the material cost of the magnetic core assembly is reduced. Since the engaging structure can increase the structural strength of the bobbin, the possibility of causing deformation of the bobbin during the winding process will be minimized. Moreover, since the thinned region has relatively low magnetic flux density, the influence of the thinned region on the overall magnetic flux of the transformer can be ignored, and the electrical characteristics are not obviously impaired. Moreover, in case that a slim-type magnetic core assembly is used as the magnetic core assembly of the transformer, the overall thickness of the transformer is reduced.

While the disclosure has been described in terms of what is presently considered to be the most practical and preferred embodiments, it is to be understood that the disclosure needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A transformer comprising:
a bobbin including a winding section;
a winding coil assembly wound on said winding section of said bobbin; and
a magnetic core assembly comprising a first magnetic core and a second magnetic core, wherein each of said first magnetic core and said second magnetic core comprises a magnetic plate, a center leg, a first lateral leg and a second lateral leg, wherein said first lateral leg and said second lateral leg are disposed on two opposite edges of said magnetic plate, wherein said magnetic plate has at least one thinned region, and said at least one thinned region is defined by said first lateral leg, said second lateral leg and said center leg collaboratively;
wherein said bobbin has at least one engaging structure corresponding to said at least one thinned region, wherein when said bobbin is arranged between said first magnetic core and said second magnetic core, said at least one engaging structure of said bobbin is engaged with said at least one thinned region.

2. The transformer according to claim 1, wherein said thinned region is defined by an end edge of said first lateral leg, an end edge of said second lateral leg and said center leg collaboratively, wherein a first side of said thinned region is determined according to the shortest distance between said end edge of said first lateral leg and said center leg, and a second side of said thinned region is determined according to the shortest distance between said end edge of said second lateral leg and said center leg.

3. The transformer according to claim 1, wherein said thinned region is a concave structure.

4. The transformer according to claim 3, wherein said engaging structure of said bobbin is a convex structure corresponding to said concave structure of said thinned region.

5. The transformer according to claim 1, wherein a surface of said thinned region has a first slant, wherein said first slant is slant from said center leg to an exterior.

6. The transformer according to claim 5, wherein said engaging structure of said bobbin has a second slant corresponding to said first slant, wherein said second slant is slant from an exterior to an interior.

7. The transformer according to claim 1, wherein said magnetic plate has a step structure formed by said thinned region.

8. The transformer according to claim 1, wherein said center leg, said first lateral leg and said second lateral leg are vertically protruded from a surface of said magnetic plate.

9. The transformer according to claim 1, wherein said center leg is a cylindrical post and located at a center of said magnetic plate.

10. A magnetic core, comprising:
a magnetic plate having at least one thinned region;
a center leg vertically protruded from a surface of said magnetic plate;
a first lateral leg vertically protruded from said surface of the magnetic plate; and
a second lateral leg vertically protruded from said surface of said magnetic plate, wherein said first lateral leg and said second lateral leg are disposed on two opposite edges of said magnetic plate, wherein said at least one thinned region is defined by said first lateral leg, said second lateral leg and said center leg collaboratively.

11. The magnetic core according to claim 10, wherein said thinned region is defined by an end edge of said first lateral leg, an end edge of said second lateral leg and said center leg collaboratively, wherein a first side of said thinned region is determined according to the shortest distance between said end edge of said first lateral leg and said center leg, and a second side of said thinned region is determined according to the shortest distance between said end edge of said second lateral leg and said center leg.

12. The magnetic core according to claim 10, wherein said thinned region is a concave structure.

13. The magnetic core according to claim 10, wherein a surface of said thinned region has a slant, wherein said slant is slant from said center leg to an exterior.

14. The magnetic core according to claim 10, wherein said magnetic plate has a step structure formed by said thinned region.

15. The magnetic core according to claim 10, wherein said center leg is a cylindrical post and located at a center of said magnetic plate.

16. A bobbin for a transformer, wherein said transformer comprises a magnetic core having at least one thinned region, said bobbin comprising:
a main body having a channel;
a top plate and a bottom plate disposed on two opposite ends of said main body respectively, wherein said main body, said top plate and said bottom plate define a winding section for winding at least one winding coil thereon, wherein said channel passes through said main body, said top plate and said bottom plate; and
at least one engaging structure formed on an outer surface of said top plate or said bottom plate for engaging with said at least one thinned region of said magnetic core.

17. The bobbin according to claim 16, wherein said engaging structure is a convex structure.

18. The bobbin according to claim 16, wherein said engaging structure has a slant, wherein said slant is slant from an exterior to an interior.
